(19) United States
(12) Patent Application Publication
(10) Pub. No.: US 2013/0168329 A1
(43) Pub. Date: Jul. 4, 2013

(54) CONTROL OF BACTERIAL ACTIVITY, SUCH AS IN SEWERS AND WASTEWATER TREATMENT SYSTEMS

(71) Applicants: Zhiguo Yuan, Queensland (AU); Guangming Jiang, Queensland (AU); Oriol Gutierrez Garcia-Moreno, Barcelona (ES)

(72) Inventors: Zhiguo Yuan, Queensland (AU); Guangming Jiang, Queensland (AU); Oriol Gutierrez Garcia-Moreno, Barcelona (ES)

(73) Assignee: The University of Queensland, St. Lucia (AU)

(21) Appl. No.: 13/695,316

(22) PCT Filed: Apr. 27, 2011
(86) PCT No.: PCT/AU11/00481

§ 371 Date: Mar. 14, 2013

(30) Foreign Application Priority Data
Apr. 28, 2010 (AU) 2010901790
Apr. 4, 2011 (AU) 2011901238

(51) Int. Cl. C02F 1/72

(52) U.S. Cl. CPC C02F 1/72
USPC 210/758

(57) ABSTRACT

A method for controlling the activity of sulfate reducing bacteria or methanogenic archaea (or both) in environments containing such organisms comprising treating the environment with free nitrous acid (HNO₂) or with a solution containing nitrite (NO₂⁻) having a pH of less than 7 or by adding nitrite to the environment and having a pH of less than 7 in the environment. The method can also disrupt biofilms.

### FIELD OF THE INVENTION

The present invention relates to a method for controlling the activity of sulfate reducing bacteria and/or methanogenic archaea (in some literature, methanogenic archaea have been incorrectly referred to as methanogenic bacteria, which are also included in this patent) (or both) in environments containing such organisms. In some aspects, the present invention relates to a method for controlling the activity of sulfate reducing bacteria and methanogenic archaea (or both) in sewers or wastewater treatment systems. The present invention also relates to a method for treating or controlling biofilm in sewers.

### BACKGROUND TO THE INVENTION

Sulfate reducing bacteria and methanogenic archaea (also referred to as methanogens) are groups of microorganisms present in a wide range of environments including marine sediments, hot springs, oil reservoirs, UASB reactors, sewers and wastewater treatment systems. Their presence in sewer networks and other wastewater treatment systems is considered unfavourable due to their capacity to produce hydrogen sulfide and methane under anaerobic conditions. Emission of hydrogen sulfide to the gas phase leads to a number of deleterious effects including corrosion of sewer infrastructure, generation of noxious odours and health problems. Methane is an explosive gas at concentrations of 5-15%, and is also a potent greenhouse gas.

Sulfide is generated in sewers by sulfate-reducing bacteria (SRB) present in sewer biofilms under anaerobic conditions (USEPA, 1974; Bowker et al., 1989). When sulfides build up in the aqueous phase they can be emitted to the sewer atmosphere as H₂S gas, which induces damage to sewer concrete structures and creates occupational hazards and odour problems (Thistlethwayte, 1.972; Bowker et al., 1989; Hvitved-Jacobsen, 2002). A number of sulfide control strategies and technologies are being used by the wastewater industry. These methods can be roughly divided into three categories, namely the inhibition of bacterial activities of sewer biofilms thus reducing the production of sulfide and other odorous compounds, the chemical and/or biological oxidation of sulfide formed, and the reduction of H₂S transfer from liquid phase to gas phase.

Sulfide removal by chemical oxidation has been achieved through the injection of ozone, hydrogen peroxide, chlorine or potassium permanganate (Tomar and Abdullah, 1994; Boon, 1995; Charron et al., 2004). Biological sulfide oxidation has been achieved with the addition of oxygen, nitrate and nitrite, while oxygen injection induces both chemical and biological oxidation of sulfide (Gutierrez et al., 2008). The addition of nitrate and nitrite salts stimulates the development of nitrate-reducing, sulfide-oxidising bacteria, thus achieving sulfide oxidation with nitrate or nitrite as the electron acceptor (Bentzen et al., 1995; Nemati et al., 2001; Yang et al., 2005; Mohanakrishnan et al., 2009). These strategies for controlling sulfide removal will require the continuous addition of oxidants, which incurs substantial operating, costs.

The reduction of H₂S transfer from water phase to gas phase can be achieved by pH elevation (Thistlethwayte, 1972; Gutierrez et al., 2009) or addition of metal salts (Bowker et al., 1989). Molecular H₂S is the form of sulfide released from water to air. In water, dissolved H₂S forms chemical equilibrium with HS⁻ and S²⁻ with ratios between the three species determined by pH and temperature, among other factors. The proportion, of H₂S is reduced when pH is increased. pH elevation through addition of e.g. Mg(OH)₂ is commonly used for reducing H₂S transfer. The reduction of molecular H₂S can also be achieved through precipitation of HS⁻ and/or S²⁻ with metal salts. The precipitation of HS⁻ and S²⁻ results in lowered total dissolved sulfide concentration and hence lowered dissolved H₂S concentration. Iron salts, either in the form of ferrous or ferric ions, have been widely used for the abatement of sulfide induced, problems in sewer networks (USEPA, 1974; Jameel, 1989; Hvitved-Jacobsen, 2002). These strategies also require continuous addition of chemicals, incurring substantial operating costs.

Addition of a strong base to elevate pH in wastewater to 11 to 13 (pH shock) has been used to deactivate bacteria in sewer biofilms (MMBW, 1989). Similarly, the addition of inhibitors such as biocides and molybdate has also been proposed to inhibit the production of H₂S (Nemati et al., 2001). Inhibition of sulfide production by addition of alternative electron acceptors such as oxygen, nitrate and nitrite has also been reported (Bentzen et al., 1995; Hobson and Yang, 2000). However, recent studies have shown that oxygen and nitrate have no long-lasting inhibitory/toxic effects on SRB in sewer biofilms (Gutierrez et al., 2008; Mohanakrishnan et al., 2008). In comparison to the previous two categories of control strategies, this category of control strategy does not require permanent or continuous dosage of chemicals. Intermittent addition of the chemicals is expected to be adequate. The “pH shock” technology has been demonstrated to be effective in reducing the activity, of sulfate reducing bacteria (SRB). However, the activity of the sulfate reducing bacteria resumes quickly in 1-2 weeks. Therefore the dosage of strong base has to be applied frequently (e.g. weekly), incurring large costs. The limited use of this technology by the wastewater industry could imply that it is likely to be cost prohibitive.

There exists a need to develop a method for controlling the activity of sulfate reducing bacteria and/or methanogenic archaea (or both) in environments containing such organisms, which overcomes or at least ameliorates the above disadvantages, or provides a commercial alternative.

Bacterial growth in sewer pipes also results in the formation of a biofilm lining the inner wall of the pipes. The biofilm in sewer pipes can attain significant thickness, for example, of the order of millimetres to tens of millimetres. The presence of the biofilm in sewer pipes has at least three undesirable side-effects, these being (1) microorganisms in the biofilm are somewhat protected from the main flow of liquid through the sewer; (2) flow area in the pipe is decreased, and (3) the friction between water flow and pipe walls increases and hence the energy consumption increases. Therefore, it becomes difficult to treat microorganisms in the biofilm by adding treatment agents to the flow in the sewer, as the biofilm acts to separate the treatment agents from the microorganisms. In this regard, the treatment agents will typically have to diffuse into the biofilm, thereby requiring significantly higher concentrations of treatment agents and longer addition of treatment agents to the sewer in order to adequately treat the biofilm.

### BRIEF DESCRIPTION OF THE INVENTION

In a first aspect; the present invention provides a method for controlling the activity of sulfate reducing bacteria or methanogenic archaea (on both) in environments containing such organisms comprising treating the environment with free nitrous acid (HNO₂).

In a second aspect, the present invention provides a method for controlling the activity of sulfate reducing bacteria or methanogenic archaea (or both) in environments containing such organisms comprising treating the environment with a solution containing nitrite (NO₂⁻) having a pH of less than 7 or by adding nitrite to the environment and having a pH of less than 7 in the environment.

It is believed that the method should also be capable of controlling the activity of other microorganisms. Accordingly, in another aspect, the present invention provides a method for controlling the activity of microorganisms in environments containing such microorganisms comprising treating the environment with free nitrous acid (HNO₂).

In one embodiment, the method is used for controlling the activity of sulfate reducing bacteria and/or methanogenic archaea or both) in wastewater systems including wastewater collection systems. The wastewater collection systems are also referred to as sewer systems. The sewer system may include a biofilm growing on the walls of pipes or vessels and the sulfate reducing bacteria and/or methanogenic archaea may be present in the biofilms. Free nitrous acid may be added to the wastewater flowing through the sewer system. Alternatively, nitrite may be added to the wastewater flowing through the sewer system. Nitrite may be added by adding a solution of nitrite, such as an acidified solution of nitrite. Alternatively, a solution of nitrite and an acidic solution may be added to the environment.

The present inventors have surprisingly discovered that treating, an environment containing sulfate reducing bacteria and/or methanogenic archaea with free nitrous acid inhibits bacterial and archael activity and results in the reduction of sulfide and methane production. Furthermore, the present inventors have found that treatment of the environment with free nitrous acid for even a relatively short period of time can result in a relatively long term reduction in sulfide and methane production. Therefore, intermittent treatments of the environment with free nitrous acid is likely to provide a viable strategy for controlling the activity of the sulfate reducing bacteria and/or methanogenic archaea in the environment. This, of course, has apparent cost benefits.

In one embodiment, the present invention comprises adding nitrite to the environment at a pH of less than 7. Preferably, the pH falls within the range of 2.0 to 7.0, more preferably between 2 and 4. However, effective treatment may be achieved using a pH in the higher part of this range, such as a pH of between 6 and 7, or even between 6.0 and 6.5, when nitrite is added to the environment.

In some embodiments, the method of the present invention comprises adding nitrite and acid to the environment. The nitrite and the acid may be added simultaneously. Alternatively, the acid may be added before the nitrite. As a further alternative, the acid may be added after the nitrite. However, where separate additions of acid and nitrite occur, it is desirable that a reasonably short timeframe passes between the separate additions of the acid and the nitrite. Effectively, the nitrite and the acid should be added sufficiently closely in time so that they are effectively added to the same hatch of wastewater. Desirably, the nitrite addition and the acid addition occur more or less simultaneously.

In another embodiment, the acid and nitrite are premixed with each other to generate free nitrous acid and the free nitrous acid is then added to the environment being treated. In these embodiments, a solution containing free nitrous acid is added to the environment.

In some embodiments of the present invention, an acidified nitrite solution or nitrite and acid solutions are added to result in at least 0.05 ppm free nitrous acid in wastewater. In other embodiments, an acidified nitrite solution or nitrite and acid solutions are added to result in at least 0.1 ppm, preferably 0.3 ppm free nitrous acid in wastewater, more particularly at least 0.5 ppm free nitrous acid, even more particularly at least 1 ppm free nitrous acid or even higher concentrations of free nitrous acid.

In one embodiment, the method of the present invention relates to a method for controlling the activity of sulfate reducing bacteria and/or methanogenic archaea in a wastewater system, such as a sewer system. In this embodiment, the wastewater flowing through the sewer may be treated with the free nitrous acid. For example, nitrite and acid may be added to the wastewater flowing through the sewer system. It has been, found that this is effective to inhibit the activity of the sulfate reducing bacteria and/or methanogenic archaea that are present in a biofilm growing in the sewer system.

In some embodiments of the present invention, the method comprises the steps of intermittently treating the environment with the free nitrous acid. In this embodiment, the method of the present invention may comprise treating the environment with free nitrous acid over a relatively short period of time, allowing a relatively long, period of time to pass and subsequently treating the environment with free nitrous acid over a long period of time (and so forth). For example, the environment may be treated with free nitrous acid for a period of time ranging from 1 hour to a few days (such as up to 7 days), or from 1 hour to about 1 day, or even from 4 hours to 16 hours, or even for about 6 hours, followed by allowing a period of time of from 5 days to 40 days, more suitably from 10 days to 35 days, even more suitably from 20 days to 30 days, to pass before again treating the environment with free nitrous acid. It will be understood that these time periods should be considered to be indicative only and that the present invention should not be considered to be limited to those time periods. Indeed, the present inventors believe that the optimum time periods for treatment of environments, such as sewer systems, will depend upon the particular operating parameters for the particular environments. For example, present results indicate that the activity of methanogens takes several months to recover to pre-treatment levels whereas sufate reducing bacteria recover more quickly, in the order of a few weeks. Thus, for methane control, a treatment interval, in the order of one month to a few months may be appropriate whereas for sulfate reducing bacteria, a treatment interval of one week to one month, such as two weeks, may be more appropriate. It will be understood that if both methanogens and sulfate reducing bacteria are present, the shorter treatment interval appropriate for sulfate reducing bacteria should be utilised. The present inventors are of the view that the person skilled in the art would readily be able to determine the optimum time periods for treatment and rest by undertaking quite straightforward experiments.

In another embodiment, the FNA/nitrite/acid is added as described above for a duration also as described above. Addition of the FNA/nitrite/acid stream is then stopped for a period of time, such as a few days, to let the wastewater flow wash away the weakened biofilm, and to expose inner biofilm layers to the environment/wastewater. Further FNA/nitrite/acid dosage is then applied. The further dosage could be applied for a duration as described above, or a shorter duration of dosage could be used. It is expected that SRB and methanogens are treated more thoroughly, and could be kept inactive for a longer time (many weeks or months).

The present inventors also expect that the environment will need to be treated with free nitrous acid only every few weeks. The contact time in which free nitrous acid is present in the environment is likely to be in the order of several hours only.

The concentration of nitrous acid in the environment during treatment with nitrous acid may fall within the range of from 0.1-1.0 mgN/L, more preferably from 0.1 to 0.5 mgN/L, even more preferably from 0.1-0.2 mgN/I. Again, the person skilled in the art will appreciate that the present invention should not be considered to be limited to these concentrations.

In some embodiments of the present invention, a solution containing free nitrous acid is obtained by treatment of a stream in a wastewater treatment plant. In these, embodiments, the solution containing free nitrous acid will typically be obtained by treating a stream in a wastewater treatment plant to form nitrite, with the nitrite being formed under acidic, conditions or an acid being added to the nitrite (or both).

In other embodiments, commercially available nitrites may be used as a source of nitrite. The present inventors have also found that adding free nitrous acid to a sewer has the ability to disrupt a biofilm that is formed on the sewer pipes. Accordingly, in a further aspect, the present invention provides a method for treating or disrupting a biofilm in a sewer or a wastewater treatment plant comprising the step of adding free nitrous acid to the sewer or wastewater treatment plant. The free nitrous acid may be added by way of adding a solution containing free nitrous acid to the sewer or the wastewater treatment plant.

In another aspect, the present invention provides a method for treating or disrupting a biofilm in a sewer or a wastewater treatment plant vessel or any pipe with biofilm comprising the step of adding free nitrous acid to the sewer or wastewater treatment plant or treating the sewer or a wastewater treatment plant vessel or pipe with a solution containing nitrite (NO₂⁻) having a pH of less than 7 or by adding nitrite to the sewer or a wastewater treatment plant vessel or pipe and having a pH of less than 7 in the sewer or a wastewater treatment plant vessel or pipe.

In another aspect, the present invention, provides a method for treating or disrupting a biofilm in a sewer or a wastewater treatment plant vessel or pipe comprising adding nitrite to the sewer or wastewater treatment plant vessel or pipe under conditions such that a nitrite containing solution having an acidic pH is obtained in the wastewater treatment plant vessel or pipe or sewer. In one embodiment, a solution containing nitrite (NO₂⁻) having a pH of less than 7 is added to the sewer or a wastewater treatment plant vessel or pipe. In another embodiment, nitrite is added to the sewer or a wastewater treatment plant vessel or pipe and a pH of less than 7 is formed or maintained in the sewer or a wastewater treatment plant.

In some embodiments of this aspect of the invention, the method of the present invention comprises adding nitrite and acid to the sewer or a wastewater treatment plant. The nitrite and the acid may be added simultaneously. Alternatively, the acid may be added before the nitrite. As a further alternative, the acid may be added after the nitrite. However, where separate additions of acid and nitrite occur, it is desirable that a reasonably short timeframe passes between the separate additions of the acid and the nitrite. Effectively, the nitrite and the acid should be added sufficiently closely in time so that they are effectively added to the same batch of wastewater. Desirably, the nitrite addition and the acid addition occur more or less simultaneously.

It has also been found that the method of all aspects of the present invention can be improved by also dosing with hydrogen peroxide (H₂O₂). In particular, treatment with free nitrous acid or nitrites at acidic pH, in conjunction with dosing of hydrogen peroxide, can result in a noticeable increase in the kill of sulfate reducing bacteria and/or methanogenic archaea. Accordingly, in another embodiment, the present invention further comprises treatment with free nitrous acid or nitrites at acidic pH and treatment with hydrogen peroxide. The hydrogen peroxide may be present at the same time as the free nitrous acid or nitrites at acidic pH, or the hydrogen peroxide may be added after (suitably, just after) treatment with free nitrous acid or nitrites at acidic pH or the hydrogen peroxide may be added prior to treatment with free nitrous acid or nitrites at acidic pH.

Hydrogen peroxide may be added such that the concentration of hydrogen peroxide is up to 0.500 ppm, suitable from 1 ppm to 250 ppm, even more suitably from 5 ppm to 150 ppm, more suitable, from 10 ppm to 100 ppm. Effective treatmement has been demonstrated at hydrogen peroxide levels of about 30 ppm.

Initial work conducted by the present inventors has demonstrated that dosing with a combination of free nitrous acid (or acidified nitrites) and hydrogen peroxide can achieve up to or even greater than a 99% kill (2 log reduction). This is a significant result because it allows a much wider gap or time duration between doses of chemicals as the sulphate reducing bacteria and/or methanogenic archaea will take much longer to recover, when compared to treatments that result in a lower kill.

Further enhanced kill rates can also be obtained by also treating with oxygen. Suitably, the oxygen is added at the same time as treatment with free nitrous acid or treatment with nitrites at acidic pH. Oxygen may be added such that the concentration of oxygen is up to 50 ppm, suitably from 1 ppm to 10 ppm, even more suitably from 5 ppm to 10 ppm. Effective treatment has been demonstrated at oxygen levels of less than 10 ppm, such as about 6 ppm.

Further enhanced kill rates may also be obtained by treatment with free nitrous acid or treatment with nitrites at acidic pH, followed by treatment with an alkaline material, such as caustic soda. The alkaline material may be added in an amount such that the pH following addition of the alkaline material is greater than 8, more suitably from 8 to 13, even more suitably from 9 to 12, even more suitably from 10 to 11, or even about 10.5.

### BRIEF DESCRIPTION OF THE DRAWINGS

FIG. 1 shows a graph of inhibition and recovery of SRB and MA activity, for Experiment I;

FIG. 2 shows a graph of inhibition and recovery of SRB and MA activity for Experiment II, which shows that a single dosage of FNA (6 hr) immediately inhibited SRB and MA. Slow recovery is also achieved in the following 1.5 months;

FIG. 3 shows a graph of inhibition and recovery of SRB and MA activity for Experiment III, which shows that four dosages of FNA (24 hr) suppressed sulfide and methane production. Slow recovery is also achieved in the following months;

FIG. 4A shows a graph of biofilm detachment arising from Experiment III and FIG. 4B shows a graph of dead cells in the biofilm for Experiment III. These findings show that FNA caused severe biofilm detachment, mainly during the dosing period. FIG. 4B indicated that FNA imposed severe biocidal effect on sewer biofilm cells;

FIG. 5 shows microscopic images of the biofilm after FNA treatment in Experiment III, showing dead cells in the biofilm following the treatment of Experiment III;

FIG. 6 shows a graph of daily average sulfide (A) and methane (B) concentrations in Experiment IV;

FIG. 7 shows the microbial killing (%) after being exposed to different chemicals;

FIG. 8 shows a graph of microbial killing (%) vs free nitrous acid concentration (mgN/L) for several different hydrogen peroxide concentrations; and

FIG. 9 shows a graph of microbial killing (%) vs hydrogen peroxide concentration (mg/L) with a free nitrous acid concentration of 0.26 ppm.

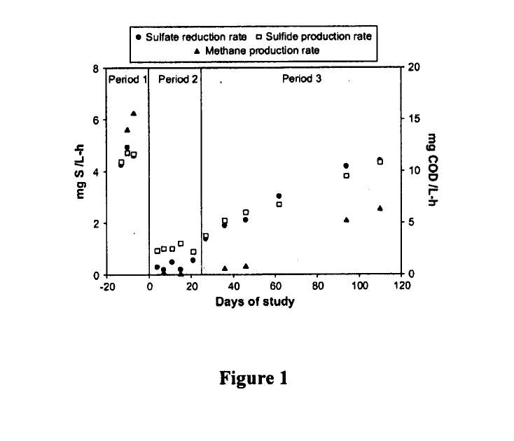

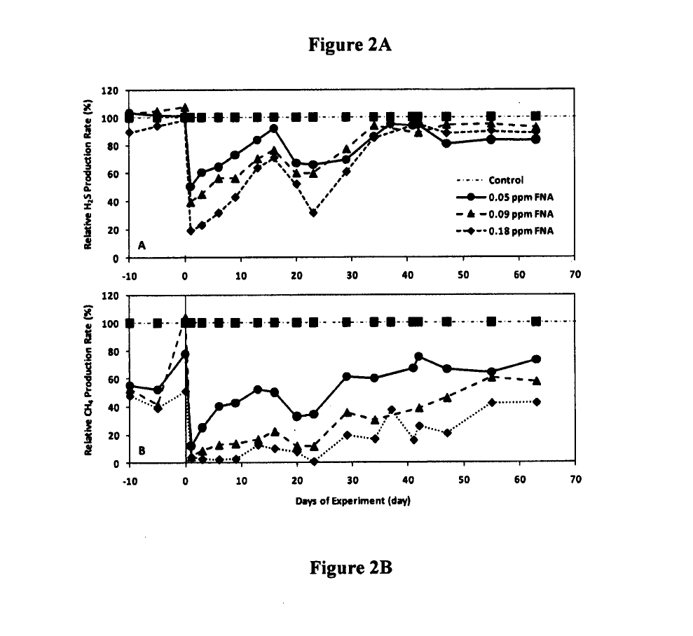

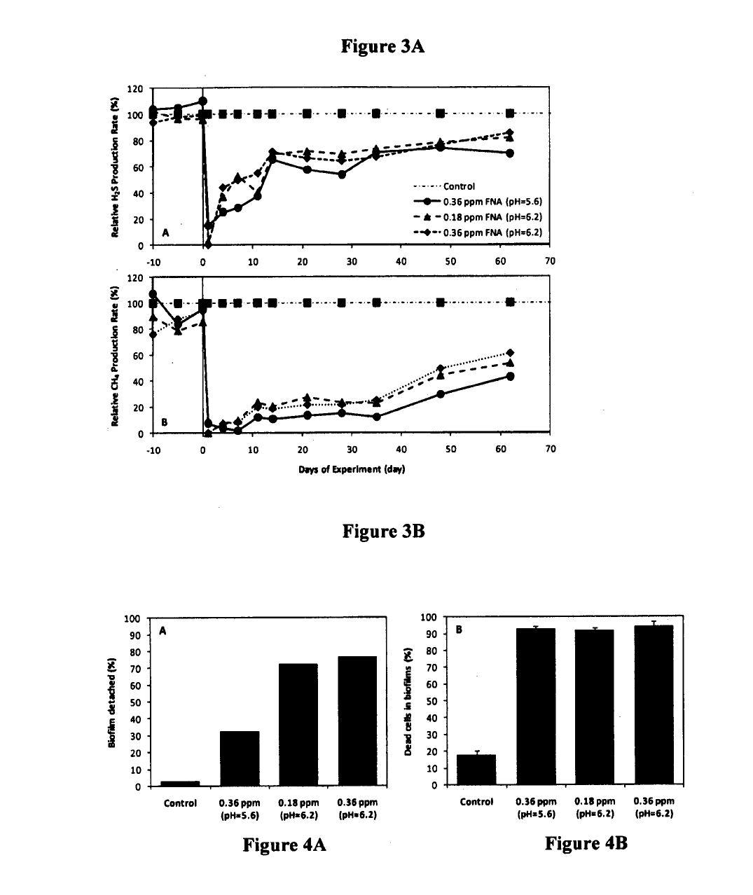

### EXAMPLES

The present invention arose from experiments that were conducted, by the present inventors into the effect of nitrite on sulfate reducing bacteria. Nitrite has long been recognized as a metabolic inhibitor for sulfate reducing bacteria (SRB). It acts upon dissimilatory sulfite reduction (dsr) enzymes by blocking the reduction of sulfite to sulfide.

In studies conducted by the present inventors involving continuous addition of nitrite to a sewage system, denitrification (both heterotrophic and autotrophic) developed in a few days after the commencement of continuous nitrite dosing. Denitrification created high pH (8-9) in sewer reactors. The pH increase was related to the nitrite dosing concentrations. The present inventors observed that nitrite inhibition effectiveness was diminished by high pH. Based on this observation, the present inventors hypothesized that nitrite effectiveness is related to the sewage pH. At; lower pH, the present inventors ghypothesised that nitrite might perform better in controlling sulfide production. Although not wishing to be bound by theory, because nitrite formed free nitrous acid (HNO₂) at lower pH, the present inventors postulated a different mechanism of nitrite inhibition: free nitrous acid is a more effective inhibitor for sulfate reducing bacteria or even that free nitrous acid exhibits toxicity to sulfate reducing bacteria. This hypothesis is of high novelty as it provides a different mechanism for nitrite inhibition on sulfate reducing bacteria metabolism. Experiments were conducted by the present inventors and free nitrous acid is believed to be very effective on inhibiting sulfate reducing bacteria.

Nitrite has also been found to be effective in reducing methane production in the studies conducted by the present inventors. This could be caused by the higher oxidation-reduction potential or the toxicity of free nitrous acid of the denitrification intermediate (NO). However, no one has reported so far about the free nitrous acid inhibition on methanogenic consortium. The free nitrous acid experiments conducted by the present inventors thus also investigated this novel aspect of free nitrous acid inhibition.

### Experiments

Four groups of experiments were conducted to investigate nitrite and free nitrous acid (in the following discussion, FNA is used to denote free nitrous acid, SRB is used to denote sulfate reducing bacteria and MA is used to denote methanogenic archaea):
Experiment I: Inhibitory effects of nitrite on SRB and MA (Mohanakrishnan et al., 2008). This constitutes a comparative example,
Experiment II: Effects of FNA on SRB and MA—laboratory study with 6 hr FNA treatment
Experiment III: Effects of FNA on SRB and MA—laboratory study with 24 hr FNA treatment
Experiment IV: Effects of FNA on SRB and MA—field study with 33 hr FNA treatment (over three days; dosed during day time only).

The first experiment was mainly focused on nitrite while other experiments targeted on FNA. Experimental details are listed in Table I below.

TABLE 1
Summary of experiments and findings.

| | | Nitrite | Dosing | | | FNA | | |
|---|---|---|---|---|---|---|---|---|
| Experiments | Sewer reactors | dosing | duration | | pH | concentrations | Inhibition | Recovery* |
| Exp. I | One reactor; | 20 mg-N/L | 24 | days | No | Up to | Residual activity | After 2.5 |
| | 16 feed | every 30 | | | adjustment. | 0.27 × 10⁻³ | after treatment: | months, |
| | pumping events | minutes, | | | (8.6~9.2 | mg-N/L | SRB: 1 mg-S/L-hr | SRB: 100%; |
| | each day; | | | | after dosing): | | MA; 0.1 mg- | MA: 42%. |
| | HRT: 30 | | | | | | CQD/L-hr | |
| | minutes to 6 | | | | | | | |
| | hours. | | | | | | | |
| | Mixing: always | | | | | | | |
| | 200 rpm | | | | | | | |
| Exp. II | Four separated | 0, 27.9, | 6 | hour | 7 in control; | 0, 0.05, 0.08, | Negligible | After 1 month, |
| | reactors; | 56.3, 110.9 | | | pH lowered, | 0.17 mg-N/L | sulfide & | SRB: 90%; |
| | 4 feed events | mg-N/L for | | | to 6.2 in feed | for R1~R4. | methane | MA: 30~50%. |
| | every day; | R1~R4, a | | | to | | production. | |
| | HRT: 6 hours | single dose | | | experimental | | | |
| | Mixing: always | for one 6 | | | reactors | | | |
| | 200 rpm | hour cycle; | | | | | | |
| Exp. III | As above | 0, 56, 112, | 24 | hours | 7.8 in control, | 0, 0.36, 0.18, | Negligible | SRB: 70-80% |
| | | 222 mg- | | | 5.6, 6.2, 6.2 | 0.36 mg-N/L | sulfide & | in two months; |
| | | N/L for | | | for R2~R4. | for R1~R4. | methane | MA: 40~60% |
| | | R1~R4, 1 | | | | | production. | recovery in |
| | | dose in | | | | | Significant | two months. |
| | | each cycle, | | | | | biofilm | |
| | | 4 dosages | | | | | detachment. | |
| | | in total. | | | | | | |

| | | | | | | | |
|---|---|---|---|---|---|---|---|
| Exp. IV | Real sewer, | 100 mgN/L | 33 hours over | 6.0 | 0.24 mgN/L. | Negligible | SRB: 100% in |
| | diameter | | three days; | | | sulfide & | three weeks |
| | 150 mm, length | | 11 hr dosage | | | methane | MA: 15% |
| | 1.1 km | | during daytime | | | production. | recovery in |
| | | | only | | | | three months |

In Experiment I, nitrite was continuously dosed in the reactor for 24 days. No sulfide and methane accumulation was observed in the reactor in the presence of nitrite. A significant reduction was observed in the sulfate reduction and methane production capabilities of the biofilm. When nitrite addition was stopped, the sulfate reduction and methane production capabilities gradually resumed, reaching 100% and 40%, respectively, of the pre-nitrite addition levels after 15 months.

In Experiment II, four reactors were dosed with FNA concentration of 0, 0.05, 0.08, 0.17 mg-N/L. A single dose of FNA at day 0, resulting in 6 hour contact between FNA and sewer biofilm, immediately inhibited SRB and MA. The recovery after the FNA dosing depended on the FNA concentrations. R4, dosed the highest FNA, took 16 days to recover to 50%. Methane was also reduced to below 20% after the FNA dosing in all cases. Methane production recovered more slowly than SRB recovery. This experiment confirmed that FNA is more effective than nitrite at the same concentration and exposure time.

Experiment III aimed to achieve complete inhibition on both sulfide and methane production. Two levels of FNA, i.e. 0.18 and 0.36 ppm, both succeeded in suppressing SRB and methanogens with 24 hour contact with biofilm. One month after stopping FNA dosage, SRB recovered to about 70% while methanogens only recovered their activity to 20%. No significant differences were found for the different FNA concentrations, which suggests that 0.18 ppm is sufficient.

By comparing the inhibition and recovery caused at 0.18 ppm with the 0.1.8 ppm results in Experiment II, longer exposure time (24 hour) achieved higher inhibition. Therefore, the effective exposure time ranges between 6 to 24 hours for an FNA concentration of 0.18 ppm.

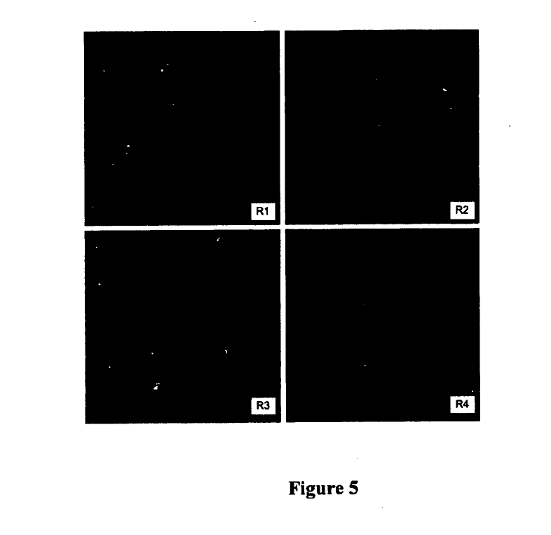

FIG. 4B shows that FNA dosed in the reactors killed over 90% of cells in the biofilm. This is also visually demonstrated by microscopic images in FIG. 5. These results show that FNA had a biocidal effect on the microorganisms in sewers biofilms, which is likely responsible for the substantially reduced sulfate-reducing and methanogenic activities.

FIG. 4A shows that FNA dosing, had a dispersal effect on the sewer biofilms, resulting in severe biofilm detachment in all the experimental reactors. This is highly beneficial.

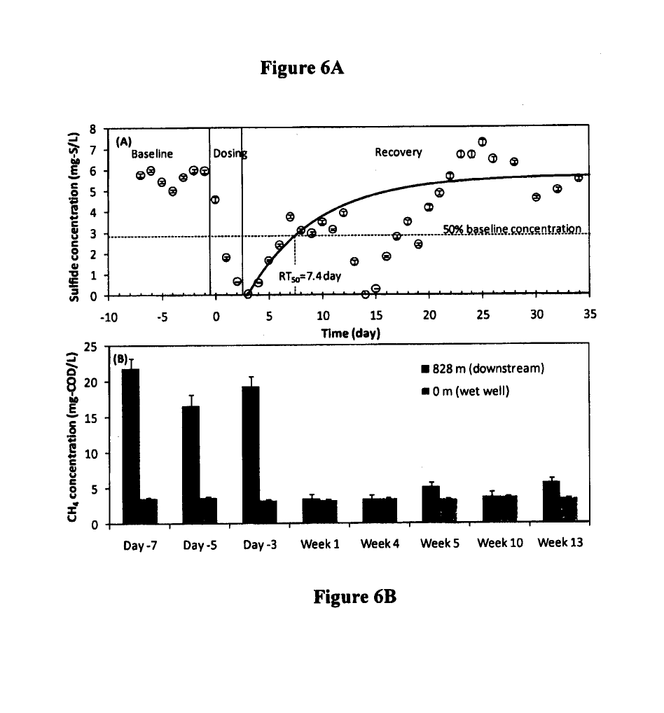

Experiment IV: FIG. 6 shows the sulfide and methane concentrations at the pumping station wet well and 828 m downstream. Complete suppression of sulfate reduction was achieved after three days, when the dosage was terminated. Sulfide production gradually recovered, reaching 50% of the initial level after 7 days. However, sulfide production dropped sharply during Days 12-14, reaching zero production on Day 14, before gradually bouncing back to the pre-nitrite dosage level three weeks after the termination of the dosage.

The strong toxic effect, of FNA on methanogens observed in the lab-scale studies was confirmed in the field trial (FIG. 6B). One month after terminating nitrite dosage, methane concentration at 828 m remained at a level similar to that measured in the wet well, indicating that the sewer biofilm ceased to produce methane in this period. Three months after the dosage, methane production recovered to <20% of the pre-dosage level.

In general, the field trial confirmed the lab study results that FNA has a long-term inhibitory effect on both sulfate reduction and methane production by anaerobic sewer biofilms. Both the field and laboratory results collectively suggest that FNA could be applied intermittently to achieve sulfide and methane control in sewers.

Experiment I demonstrated that nitrite dosing can be used to inhibit the activity of SRB and MA in sewer systems. However, this strategy relied upon continuous dosing of nitrite to the sewer system. There are apparent adverse cost impacts associated with continuous dosing of chemicals over an extended period of time. Experiments II-IV demonstrated that intermittent dosing of FNA, with the dosing taking place over a relatively short period of time, is capable of inhibiting SRB and MA for an extended period of time, thereby allowing for the possibility of intermittent dosing of chemicals. Advantageously, significant cell death of the microorganisms also occurred, which can result in the disruption and control of biofilm containing the microorganisms.

The experimental work set out above not only confirmed the effectiveness of continuous dosing of nitrite in controlling sulfide and methane production, but also revealed a new technology of free nitrous acid inhibition. This is completely different from using nitrite as metabolic inhibitor for SRB. Intermediates of nitrite denitrification could also inhibit MA. However, free nitrous acid can inhibit both SRB and MA, with a very short exposure time. Many benefits would be produced by applying free nitrous acid rather than nitrite in sewers. These advantages may include but not limited to the below:
Less amount of chemicals needed, thus lower operational costs (short dosing plus slow recovery).
Highly effective when FNA is present.
Long-term recovery after FNA being stopped.
Inhibit methane production to negligible level simultaneously.
Retain more organic carbon, particularly volatile fatty acids (VFA) for the downstream wastewater treatment plants (WWTP) (less CH4 production).
No residual effects to the environment.
Treatment and control of biofilm.

Exposure of anaerobic sewer biofilm to FNA for a short time seems to kill SRB and MA, and maybe other microorganisms. This biocidal effect of FNA is superior to other biocides. FNA does not have residual effects to the environment as nitrite can be reduced by denitrification processes. This also acts to disrupt the biofilm present in the sewer pipes.

Further experimental work was conducted to demonstrate the cell, killing capacity for free nitrous acid with hydrogen peroxide, oxygen, caustic soda and their combinations. In the experiments with free nitrous acid and caustic soda, the caustic soda was added after treatment with free nitrous acid. In these experiments, viability tests were carried out with biofilms on carriers from rising main sewer reactors. The cell killing capacity was determined for free noxious acid, hydrogen peroxide, oxygen and the combination of free nitrous acid with hydrogen peroxide, oxygen, and alkaline or caustic conditions, respectively. The conditions used are set out in Table 2:

TABLE 2

| | | Nitrite | H₂O₂ | O₂ | | FNA | Exposure |
|---|---|---|---|---|---|---|---|
| Sample | Description | (mgN/L) | (mg/L) | (mg/L) | pH | (mgN/L) | time (hr) |
| LA1 | Control | 0 | 0 | 0 | 7.5 | 0 | 6 |
| LA2 | FNA | 100 | 0 | 0 | 6 | 0.26 | 6 |
| LA3 | FNA + H₂O₂ | 100 | 30 | 0 | 6 | 0.26 | 6 |
| LA4 | FNA + O₂ | 100 | 0 | 6 | 6 | 0.26 | 6 |
| LA5 | H₂O₂ | 0 | 30 | 0 | 7.5 | 0 | 6 |
| LA6 | O₂ | 0 | 0 | 6 | 7.5 | 0 | 6 |
| LA7 | FNA → Caustic | 100 | 0 | 0 | 6 → 10.5 | 0.26 | 6 → 2 |

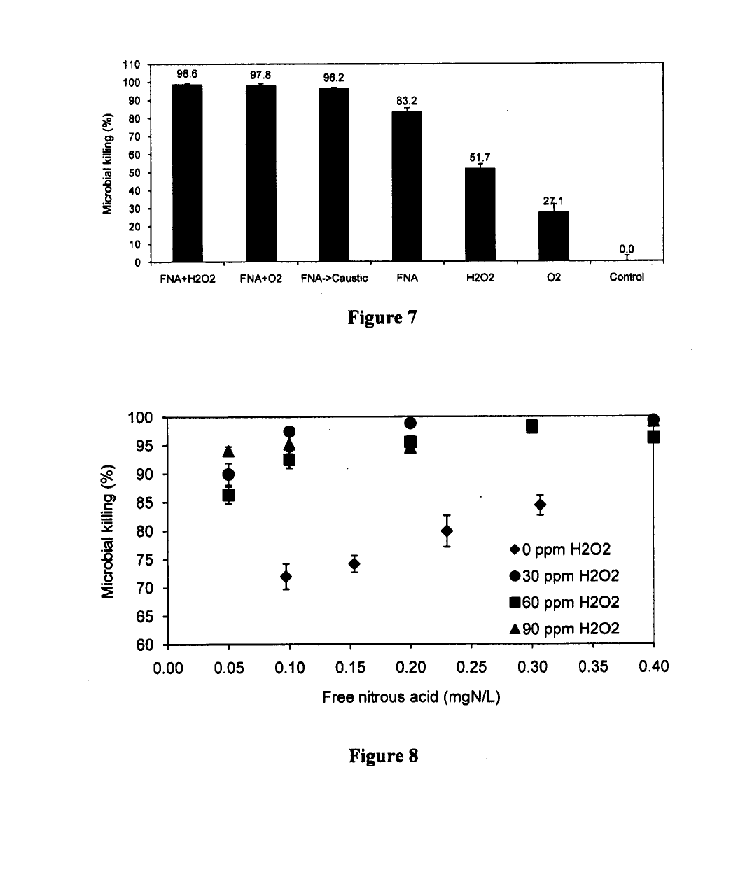

The results of the above experiments are shown in FIG. 7. FIG. 7 shows that FNA+H₂O₂ is the most powerful killing combination, followed by FNA→Caustic, FNA+O₂, and FNA.

The result showed that H₂O₂ enhanced the biocidal effect of acidified nitrite towards anaerobic sewer biofilms. This is particularly useful effect as hydrogen peroxide can be easily added to the sewer line together with acidified nitrite.

The results also show that FNA dosing and caustic shock, by themselves, are capable of significantly inactivating biofilm cells.

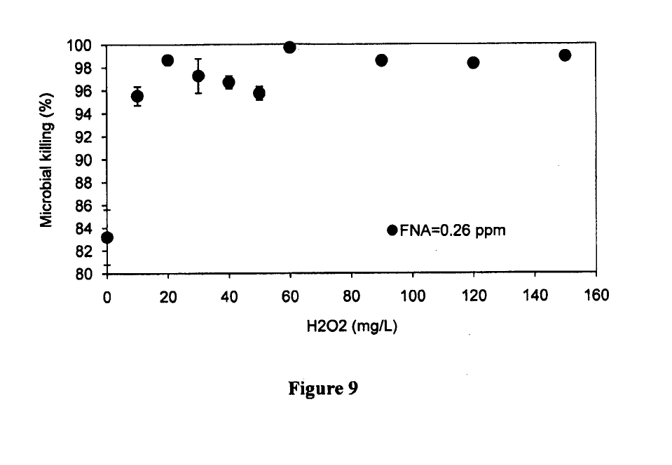

FIGS. 8 and 9 show further results demonstrating the synergistic effect of FNA and hydrogen peroxide on the microbial killing achieved.

### Further Examples

A total of 20 tests were generated, with 6 tests at the center of parameters FNA=0.329 mgN/L, H₂O₂=40 mg/L, and exposure of 6 hour. Eight tests were factorial and six tests are star tests distributing around the circumference with a radius of 1.682. The overall experimental design and detailed experimental data for the killing efficiency are listed in Table 3.

The observed killing efficiencies varied between 92.9 and 99.8%. These results clearly indicated that the chosen factors had an significant impact on the killing efficiency.

TABLE 3
Three-factor five-level Central Composite
Designs and experimental parameters.

| | Run | FNA | H₂O₂ | Exposure | Nitrite | Microbial |
|---|---|---|---|---|---|---|
| No. | Order | (mgN/L) | (mg/L) | (hour) | (mg/L) | killing (%) |
| 1 | 13 | 0.329 | 40.0 | 2.6 | 100 | 92.9 |
| 2 | 1 | 0.229 | 20.0 | 4.0 | 68 | 93.7 |
| 3 | 3 | 0.229 | 60.0 | 4.0 | 68 | 97.4 |
| 4 | 5 | 0.429 | 20.0 | 4.0 | 131 | 95.1 |
| 5 | 7 | 0.429 | 60.0 | 4.0 | 131 | 95.9 |
| 6 | 9 | 0.161 | 40.0 | 6.0 | 47 | 99.0 |
| 7 | 10 | 0.497 | 40.0 | 6.0 | 152 | 99.4 |
| 8 | 11 | 0.329 | 6.4 | 6.0 | 100 | 98.8 |
| 9 | 12 | 0.329 | 73.6 | 6.0 | 100 | 99.0 |
| 10 | 15 | 0.329 | 40.0 | 6.0 | 100 | 99.0 |
| 11 | 16 | 0.329 | 40.0 | 6.0 | 100 | 99.5 |
| 12 | 17 | 0.329 | 40.0 | 6.0 | 100 | 99.3 |
| 13 | 18 | 0.329 | 40.0 | 6.0 | 100 | 99.4 |
| 14 | 19 | 0.329 | 40.0 | 6.0 | 100 | 99.2 |
| 15 | 20 | 0.329 | 40.0 | 6.0 | 100 | 99.6 |
| 16 | 2 | 0.229 | 20.0 | 8.0 | 68 | 99.3 |
| 17 | 4 | 0.229 | 60.0 | 8.0 | 68 | 98.8 |
| 18 | 6 | 0.429 | 20.0 | 8.0 | 131 | 98.7 |
| 19 | 8 | 0.429 | 60.0 | 8.0 | 131 | 99.5 |
| 20 | 14 | 0.329 | 40.0 | 9.4 | 100 | 98.9 |

Throughout the specification, the term “Comprising” and its grammatical equivalents should be taken to have an inclusive meaning unless the context of use indicate otherwise.

Those skilled in the art will appreciate that the present invention may be susceptible to variations and modifications other than those specifically described. It will be understood that the present invention encompasses all such variations and modifications that fall within its spirit and scope.

### REFERENCES

Bent en, G., Smith, A. T., Bennett, D., Webster, N J., Reinholt, F., Sletholt, E. and Hobson, J. (1995) Controlled, dosing of nitrate for prevention of H₂S in a sewer network and the effects on the subsequent treatment processes. Water Science and Technology 31(7), 293-302.
Boon, A. G. 1995. Septicity in sewers: Causes, consequences and containment. Water Sci. Technol. 31(7), 237-253.
Bowker, R. P. G., Smith, J. M. and Webster, N. A. (1989) Odor and corrosion control in sanitary sewerage systems and treatment plants, Park Ridge, N.J., U.S.A.
Charron, I., Feliers, C., Couvert, A., Laplanche, A., Patria, L. and Requieme, B. (2004) Use of hydrogen peroxide in scrubbing towers for odor removal in wastewater treatment plants. Water Science and Technology 50(4), 267-274,
Gutierrez, O., Mohanakrishrian, J., Sharma, K. R., Meyer, R. L., Keller, J. and Yuan, Z. (2008) Evaluation of oxygen injection as a means of controlling sulfide production in a sewer system. Water Research 42(17), 4549-4561.
Gutierrez, O., Park, D., Sharma, K. R. and Yuan, Z. (2009) Effects of long-term, pH elevation on the sulfate-reducing and methanogenic activities of anaerobic sewer biofilms. Water Research 43: 2549-2557.
Hobson, J. and Yang, S. (2000). The ability of selected chemicals for suppressing odour development in rising main. Water Science and Technology. 41 (6): 165-173.
Hvitved-Jacobsen, T. (2002) Sewer processes: microbial and chemical process engineering of sewer networks, CRC Press, Boca Raton London New York. Washington, D.C.
Jameel, P. (1989) The use of ferrous chloride to control dissolved sulfides in interceptor sewers. Journal Water Pollution Control Federation 61(2), 230-236. MMBW (Melbourne and Metropolitan Board of Works) (1989) Hydrogen Sulfide Control Manual. Melbourne.
Mohanakrishnan, J., Gutierrez, O., Meyer, R. L. and Yuan, Z. (2008) Nitrite effectively inhibits sulfide and methane production in a laboratory scale sewer reactor. Water Research 42(14), 3961-3971.
Mohanakrishnan, J., Gutierrez, O., Sharma, K. R., Guisasola, A., Werner, U., Meyer, R. L., Keller, J. and Yuan, Z. (2009) Impact of nitrate addition on biofilm properties and activities in rising main sewers. Water Research 43: 4225-4337.
Nemati, M., Mazutinec, T. J., Jenneman, G. E. and Voordouw, G. (2001) Control of biogenic H2S production with nitrite and molybdate. Journal of Industrial Microbiology & Biotechnology 26(6), 350-355.
Thistlethwayte DKB (1972) The control of sulphides in sewerage systems, Butterworth Pty. Ltd., Sydney.
Tomar, M. and Abdullah, T. H. A. (1994) Evaluation of chemicals to control the generation of malodorous hydrogen sulfide in waste water. Water Research 28(12), 2545-2552.
US EPA (1974). Process design manual for sulfide control in sanitary sewerage systems. [Washington, D.C.], .s.n.].
Yang, W., Vollertsen, J., Hvitved-Jacobsen, T. (2004). Anoxic control of odour and corrosion from sewer networks. Wat. Sci. Technol. 50(4),341-349.

1. A method for controlling the activity of sulfate reducing bacteria or methanogenic archaea (or both) in environments containing such organisms comprising treating the environment with free nitrous acid (HNO₂).

2. A method for controlling the activity of sulfate reducing bacteria or methanogenic archaea (or both) in environments containing such organisms comprising treating the environment with a solution containing nitrite (NO₂⁻) having a pH of less than 7 or by adding nitrite to the environment and having a pH of less than 7 in the environment.

3. A method for controlling the activity of microorganisms in environments containing such microorganisms comprising treating the environment with free nitrous acid (HNO₂).

4. A method as claimed in claim 1 comprising adding nitrite to the environment at a pH within the range of 2.0 to 7.0, more preferably between 2 and 4. or at a pH of between 6 and 7, or at a pH of between 6.0 and 6.5, when nitrite is added to the environment.

5. A method as claimed in claim 1 comprising adding nitrite and acid to the environment wherein the nitrite and the acid are added simultaneously, or the acid is added before the nitrite, or the acid is added after the nitrite.

6. A method as claimed in claim 1 wherein the acid and nitrite are premixed with each other to generate free nitrous acid and the free nitrous acid is then added to the environment being treated.

7. A method as claimed in claim 1 wherein an acidified nitrite solution or nitrite and acid solutions are added to result in at least 0.05 ppm free nitrous acid in wastewater, or at least 0.1 ppm free nitrous acid in wastewater, or at least 0.3 ppm free nitrous acid in wastewater, or at least 0.5 ppm free nitrous acid in wastewater, even more particularly at least 1 ppm free nitrous acid in wastewater.

8. A method as claimed in claim 1 wherein the method comprises the steps of intermittently treating the environment with free nitrous acid.

9. A method as claimed in claim 8 comprising treating the environment with free nitrous acid over a relatively short period of time ranging from 1 hour to a few days (such as up to 7 days), or from 1 hour to about 1 day, or even from 4 hours to 16 hours, or even for about 6 hours, allowing a relatively long period of time of from 5 days to 40 days, more suitably from 10 days to 35 days, even more suitably from 20 days to 30 days, to pass and subsequently treating the environment with free nitrous acid over a short period of time (and so forth).

10. A method as claimed in claim 1 wherein free nitrous acid or nitrite and acid is added, whererafter addition of the free nitrous acid or nitrite and acid is then stopped for a period of time to let the wastewater flow wash away a weakened biofilm and to expose inner biofilm layers to the environment/wastewater, followed by further dosage of free nitrous acid or nitrite and acid

11. A method as claimed in claim 1 wherein a concentration of nitrous acid in the environment during treatment with nitrous acid falls within the range of from 0.1-1.0 mgN/L, more preferably from 0.1 to 0.5 mgN/L, even more preferably from 0.1-0.2 mgN/I.

12. A method as claimed in claim 1 wherein a solution containing free nitrous acid is obtained by treatment of a stream in a wastewater treatment plant by treating a stream in a wastewater treatment plant to form nitrite, with the nitrite being formed under acidic conditions or an acid being added to the nitrite (or both).

13. A method as claimed in claim 1 wherein commercially available nitrites are used as a source of nitrite.

14. A method for treating or disrupting a biofilm in a sewer or a wastewater treatment plant comprising the step of adding free nitrous acid to the sewer or wastewater treatment plant.

15. A method for treating or disrupting a biofilm in a sewer or a wastewater treatment plant vessel or any pipe with biofilm comprising the step of adding free nitrous acid to the sewer or wastewater treatment plant or treating the sewer or a wastewater treatment plant vessel or pipe with a solution containing nitrite (NO₂⁻) having a pH of less than 7 or by adding nitrite to the sewer or a wastewater treatment plant vessel or pipe and having a pH of less than 7 in the sewer or a wastewater treatment plant vessel or pipe.

16. A method for treating or disrupting a biofilm in a sewer or a wastewater treatment plant vessel or pipe comprising adding nitrite to the sewer or wastewater treatment plant vessel or pipe under conditions such that a nitrite containing solution having an acidic pH is obtained in the wastewater treatment plant vessel or pipe or sewer.

17. A method as claimed in claim 16 wherein a solution containing nitrite (NO₂⁻) having a pH of less than 7 is added to the sewer or a wastewater treatment plant vessel or pipe, or nitrite is added to the sewer or a wastewater treatment plant vessel or pipe and a pH of less than 7 is formed or maintained in the sewer or the wastewater treatment plant.

18. A method as claimed in claim 1 comprising also dosing with hydrogen peroxide (H₂O₂).

19. A method as claimed in claim 18 wherein the hydrogen peroxide is present at the same time as the free nitrous acid or nitrites at acidic pH, or the hydrogen peroxide is added after treatment with free nitrous acid or nitrites at acidic pH or the hydrogen peroxide is added prior to treatment with free nitrous acid or nitrites at acidic pH.

20. A method as claimed in claim 18 wherein hydrogen peroxide is added such that the concentration of hydrogen peroxide is up to 500 ppm, or from 1 ppm to 250 ppm, or from 5 ppm to 150 ppm, or from 10 ppm to 100 ppm.

21. A method as claimed in claim 20 wherein hydrogen peroxide is added such that the concentration of hydrogen peroxide is about 30 ppm.

22. A method as claimed in claim 1 comprising also treating the environment with oxygen.

23. A method as claimed in claim 22 wherein the oxygen is added at the same time as treatment with free nitrous acid or treatment with nitrites at acidic pH.

24. A method as claimed in claim 22 wherein oxygen is added such that the concentration of oxygen is up to 50 ppm, or from 1 ppm to 10 ppm, or suitably from 5 ppm to 10 ppm.

25. A method as claimed in claim 1 comprising treating the environment with free nitrous acid or treatment with nitrites at acidic pH, followed by treatment with an alkaline material.

26. A method as claimed in claim 25 wherein the alkaline material is caustic soda.

27. A method as claimed in claim 25 wherein the alkaline material is added in an amount such that the pH following addition of the alkaline material is greater than 8, or from 8 to 13, or from 9 to 12, even more suitably from 10 to 11, or even about 10.5.
